(19) United States
(12) Patent Application Publication
(10) Pub. No.: US 2017/0007955 A1
(43) Pub. Date: Jan. 12, 2017

(54) Photo-Catalytic Oxidation Reaction System

(71) Applicant: Pioneer Astronautics, Lakewood, CO (US)

(72) Inventors: Thomas Henshaw, Monument, CO (US); Robert Zubrin, Golden, CO (US); Mark Berggren, Golden, CO (US); Boris Nizamov, Highlands Ranch, CO (US); Stacy Lorraine Carrera, Golden, CO (US)

(73) Assignee: Pioneer Astronautics, Lakewood, CO (US)

(21) Appl. No.: 15/203,563

(22) Filed: Jul. 6, 2016

Related U.S. Application Data
(60) Provisional application No. 62/190,468, filed on Jul. 9, 2015.

(51) Int. Cl. B01D 53/00

(52) U.S. Cl. CPC B01D 53/007; B01D 2259/802; B01D 2259/804

(57) ABSTRACT

A novel photocatalytic oxidation system that combines long lifetime, high-power light emitting diodes (LEDs) with efficient, visible light-activated photocatalysts for the destruction of Volatile Organic Compounds (VOCs) and other pathogens in air and water flow systems under ambient conditions of temperature and pressure is described. The technology uses the combination of visible photocatalysts with robust visible LEDs, uniform side emission fiber optics, and efficient catalyst surface illumination technologies to create a photocatalytic oxidation unit for air and water purification. This combined approach leads to numerous performance benefits including high VOC conversion efficiency, compact reactor volume, low pressure drop, and the elimination of conventional ultraviolet (UV) mercury lamp logistics and hazards.

### RELATED APPLICATIONS

This application claims the benefit of U.S. Provisional Application No. 62/190,468 filed Jul. 9, 2015 entitled “Photo-Catalytic Oxidation Reaction System” which is incorporated herein by reference.

### GOVERNMENT SUPPORT STATEMENT

This invention was made with Government support under contract NNX13CM13P awarded by NASA. The Government has certain rights in this invention.

### FIELD OF THE INVENTION

The present invention relates generally to the oxidation and destruction of chemical and biological materials in gas and aqueous flow streams, and more particularly to a photocatalytic oxidation reactor.

### BACKGROUND OF THE INVENTION

Traditional chemical and biological treatment technologies for chemical pollutants and biological pathogens include physical-chemical and biotechnological methods. Well-known physio-chemical examples include adsorption, absorption, and thermal and catalytic oxidation. The standard examples of biological technologies include biofiltration, bioscrubbing, and biotrickling filtration. Nevertheless, all traditional technologies show various shortcomings: (1) Absorption and adsorption methods do not destroy chemical/biological compounds, rather they transfer them into a liquid or a solid waste stream; (2) thermal and catalytic incineration necessitate high power consumption and (3) the applicability of broad-spectrum biotechnological abatement methods is limited as recalcitrant compounds such as halogenated hydrocarbons are not degraded. Because of the limitations these traditional approaches there is a need for new solutions to this problem.

### SUMMARY OF THE INVENTION

The current claims relate to a photocatalytic oxidation system that uses visible light activated nanoparticle photocatalysts to enhance the oxidation and purification of volatile organic compounds in gas streams. In some embodiments, the current claims use a reactor chamber incorporating polymeric fiber optics, a film coating of nanoparticle photocatalyst on the surface of a side emitting fiber optic, efficient visible 475 nm Light Emitting Diodesto illuminate and activate the photocatalyst, and a gas entry and exit chamber to admit volatile organic compounds and exhaust the oxidation products.

One embodiment of the invention is to provide a gas-solid oxidation reactor chamber that incorporates a plurality of LED illuminated side-emitting fiber optics and chamber wall mounted LEDs.

Another embodiment of the invention is the use of side emitting fiber optics for close-coupled, direct illumination of the photocatalyst film deposited on the outer surface of the side emitting fiber optic.

Another embodiment of the invention is that the side emitting fiber optics provides a high surface area substrate for attaching nanoparticle photocatalysts.

Another embodiment of the invention is the use of close-packed fiber optic arrangement to achieve high substrate surface area to reactor volume ratio and low pressure drop.

Another embodiment of the invention is the inclusion of a combined side emitting fiber optic and a gas distributor plate to evenly distribute the fiber optics into the reaction chamber, and facilitate a uniform gas flow field across the fiber optics in the reaction chamber.

Another embodiment of the invention is that the reactor can be oriented and freely operable in counter flow, co-flow and side flow configurations.

Another embodiment of the invention is the use of common synthesis and deposition methods including sol-gel and impregnation to load the photocatalyst onto the fiber optics.

### BRIEF DESCRIPTION OF DRAWINGS

FIG. 1 Block diagram of a photocatalytic system for oxidizing volatile organic compounds

FIG. 2 Fiber optic distributor plate geometric layout

FIG. 3 Photograph of distributed fiber optic array

FIG. 4 Photocatalytic oxidation reactor system flow diagram

FIG. 5 Photocatalyst coated side emitting fiber optics

FIG. 6 Photocatalytic destruction of ethanol in air stream flow

FIG. 7 Temperature dependence of the photocatalytic destruction of ethanol

### DETAILED DESCRIPTION

Oxidation reactions that produce free radicals are generally followed by a sequence of additional chemical reactions between the radical oxidants and other reactants (both organic and inorganic) until thermodynamically stable oxidation products are formed. The ability of an oxidant to initiate chemical reactions is measured in terms of its oxidation potential. The most powerful oxidants are fluorine, hydroxyl radicals (HO□), and ozone with oxidation potentials of 2.85, 2.70, and 2.07 electron volts, respectively (Carey, J. H., 1992; TECHCOMMENTARY, 1996). The end products of complete oxidation (called mineralization) of organic compounds are carbon dioxide (CO2) and water (H2O).

There are several approaches to generating hydroxyl radicals including electrical discharge, photolysis, photocatalysis, sonolysis, electrochemical oxidation, Fenton and photo-Fenton chemistry, and ozone.

The technique of photocatalytic oxidation involves the surface illumination of a semiconductor in which a photon with energy Eₕᵥ equal to or greater than the semiconductor band gap E_{g} excites an electron from the valence band (VB) to the conduction band (CB). When the semiconductor is photoexcited an electron (e_{cb}⁻) is promoted to the CB and a hole (h_{vb}⁺) is left behind in the VB. A variety of reaction dynamics can follow in which the energy carriers (e_{cb}⁻, h_{vb}⁺) can undergo recombination with heat generation, the electron can return to the ground state and radiate light or heat, or migrate to the surface of the semiconductor and undergo oxidation and reduction (redox) reactions with electron donor and acceptor molecules adsorbed on the surface. In the presence of O₂, e_{cb}⁻ are trapped by oxygen which results in the formation of superoxide radical anion, O₂⁻, which slows the rate of electron-hole recombination. As the holes h_{vb}⁺ migrate to the surface they can react with adsorbed H₂O to form the hydroxyl radical, HO.. Although both superoxide and hydroxyl radicals are chemically active, the hydroxyl radical is generally thought to be the primary oxidizing species in the photocatalytic oxidation of volatile organic compounds.

The basic mechanism that describes the photocatalytic oxidative process of a Volatile Organic Compound (VOC) into CO2 and H2O are presented below:

Cat+hv→Cat(e_{cb}⁻+h_{vb}⁺) (1)

H₂O→OH⁻+H⁺ (2)

h_{vb}⁺+OH⁻_{ads}→HO. (3)

HO.+VOC→CO₂+H₂O (4)

Titanium dioxide (TiO2) is the most widespread photocatalyst for VOC removal in air and aqueous systems. It is inert, stable, inexpensive, and poses no harm to the environment or humans. In short, TiO2 is an ideal photocatalyst except for two properties—its action spectrum does not extend into the visible portion of the spectrum, and its relatively low VOC oxidation activity. The band gap in TiO2 is 3.2 eV and therefore UV photons with wavelengths<388 nm are required to activate the catalyst.

The efficiency of TiO2 photocatalysts are known to be limited by the high recombination rate of the electron-hole pairs (ecb−, hvb+) during the semiconductor excitation process. Various studies have shown that doping TiO2 with nanoparticles such as the noble metals silver, gold and platinum (Okumura, K. et al., 1997, Hou X. G., et al., 2009, Shiraishi, Y., et al., 2012), or non-metals like nitrogen or carbon (Asahi, R. et al., 2001; Zou, X. et al., 2012) can substantially reduce the recombination rate, and thereby increase the activity of TiO2 by increasing the lifetime of the ecb− and hvb+ pairs.

Doping the TiO2 catalyst also has the added benefit of reducing the energy band gap to allow visible-light activation. Visible light activation is desirable as it allows access to energy efficient Light Emitting Diodes (LED), and in some cases solar light. LEDs offer high power, high brightness (up to 500 mW in a single LED), high reliability (>50,000 hours), high efficiency (10-20% electrical-optical), wide spectral source illumination in the UV-Visible portions of the light spectrum, and low cost (<$5/diode). Most industrial photocatalytic oxidation approaches that use TiO2 use mercury vapor lamps as a light source. However, illumination sources other than mercury lamps are desired since lamp lifetime is relatively short with an operational lifetime of <10,000 hours, and mercury presents a potential health hazard if the lamp is fractured.

To shift the catalyst response from UV to visible wavelengths, the electronic structure of TiO2 is typically modified by introducing metal and non-metal materials into the catalyst structure. There are a variety of proposed mechanisms that describe the origin of red-shifting to visible light absorption upon doping. These include band gap narrowing, formation of localized states above the VB and below the CB, generation of color-centers, and sensitization (Lu, G. Q., et al., 2009). Some of the more effective visible catalysts include nanoparticle noble metals, and nonmetal N and C doped TiO2 systems.

TiO2 thin films can be immobilized on various solid substrates such as borosilicate glass, fused silica, ceramic tile, and plastics. Fused silica has superior optical transparency and lends itself to a variety of readily available photocatalyst deposition techniques such as sol-gel, thermal spray, sputtering. For example, silver (Ag) nanoparticle—TiO2 films can be relatively easily prepared using a sol-gel method with Ti(OBu)4, titanium butoxide (Hou X. G., et al., 2009; Garcia-Serrano, J., et al. 2009,). Here an aqueous solution of Ti(OBu)4, ethanol, AgNO3 at pH4 produces a stable Ag+/TiO2 sol. After drying and grinding a nano-particle aggregate is formed. This is then dissolved into solution to dip coat the photocatalyst substrate. Fused silica is the preferred material if catalyst preparation and operating conditions require high temperatures, and UVA (400-320 nm) and UVB (320-290 nm) wavelengths.

Organic polymer-based fiber optics exhibit a smaller Yong's modulus, and thus are more resilient and less prone to fracturing and breakage than glass or fused silica. An organic polymer-based substrate is also less expensive than fused silica or glass, and thus are amendable to use in industrial environments where robust operation and reduced replacement costs are desired. Plastic fiber optics have larger core diameters (up to 1 mm) and operate multi-moded which allows higher transmission (for an equivalent area), higher numerical aperture, and more reflections inside the core. However, wavelengths less than 380 nm are absorbed or scattered by the impurities in the organic substrate, or absorbed by the substrate itself to lower its transmission. In addition, the temperature limit for the most polymer substrates is near 70° C.

The rate of photocatalytic disappearance of VOC species Ci can be estimated by the following simple Langmuir-Hinshelwood relationship (Turchi, C. S., et al. 1995):

$$\frac{d {C}_{i}}{d x} = ( {I}_{0}^{n} {a}_{sv} {ϕ}_{i} ) ( \frac{{K}_{i} {C}_{i}}{1 + {K}_{i} {C}_{i}} ) \qquad ( 5 )$$

where Iⁿₒ is the power dependence of the light intensity (Einstein/cm²-s), n is unity for low intensity, n is ½ at high intensity, aₛᵥ is the catalyst surface area to reactor volume (geometric surface area), cm⁻¹, φᵢ is the quantum efficiency for species i, Cᵢ is the concentration of species i, molec./cm⁻³, and Kᵢ is the binding constant of compound i, cm³/molec. Inspection of this equation leads to a better understanding of effective device design. For example, a simple but necessary condition is that the photocatalyst is only activated if photons reach and illuminate the catalyst surface. Partial illumination or intensity shadowing is known to be significant in externally illuminated substrates such as monoliths, micro-beads, zeolites. In these structures there can be large regions devoid of photon illumination. Therefore, any reactor should be designed so that the gas flow does not exclusively flow in these dark regions, and that the reaction rate or residence time of the analyte in the reactor bed is to be of sufficient duration to allow the contaminant stream to be treated. The reaction rate is surface area dependent, the larger the surface area the higher the rate of conversion. The higher the surface area to reactor volume ratio, the smaller the generator footprint will be. Further, a high aₛ enhances the surface contact time between contaminant and catalyst so that analytes and intermediates are afforded time to react and be oxidized.

It has been long recognized that external light penetration presents a significant challenge for a variety of photocatalyst substrate configurations including monoliths, packed beds, microbeads, concentric tubes, rings, slurries, etc. The concept of using a fiber optic to transmit, illuminate and support photocatalysts was first proposed by Marinangeli and Ollis, (1977). Later, Hofstadler and Bauer et al, (1994), and Peill and Hoffmann (1995), refined the method of driving a photocatalyst coated fiber optic reactor. However, these reactors were basically constructed of end-emitting, data transmission fibers which are designed to light guide down a single mode 10 □m fiber core with total internal reflection for long distances. However, for illumination of a catalyst coated on the outer wall of a fiber a different approach is warranted. In principle, the uniform illumination of a catalyst coated fiber can be obtained with a side emission fiber optic over short distances. In this regard, the side-emitting fiber optic is well-suited to generating a uniform and a highly illuminated photocatalyst surface area. There are several commercial off the shelf polymer-based side emitting fibers that are readily available and can be used in this approach.

An array of side emitting fiber optics can be arranged in a close-packed geometry resulting in a high reactor surface area to reactor volume ratio, asv. A reactor with a high surface area to volume substrate ratio is desirable since more reaction surface area is available for reactant conversion in a smaller reactor volume or package size. This means more fibers of shorter length can be used with less light attenuation and higher catalytic activity generated.

For example, the surface to volume ratio asv of a fiber optic is approximated by equation 6 where df is the fiber diameter, and F is the area packing fraction of the fiber optics:

$${a}_{sv} = \frac{4}{{d}_{f}} ( F ) \qquad ( 6 )$$

For a simple square lattice arrangement for the fiber optic packing, F is given as:

$$F = π \frac{{d}_{f}^{2}}{4 ab} \qquad ( 7 )$$

where a and b are the separation distance between fiber. Consider a fiber diameter of 0.075 cm and a fiber separation a=b=0.2 cm, the packing fraction is lowered to about 0.11 which gives a aₛᵥ ratio of 5.9 cm⁻¹. This is a very good value, and with further packing refinement a uniformly illuminated fiber with geometric surface area of over 20 cm⁻¹ can be obtained. We note that the maximum triangular packing fraction is π/2√3 compared to π/4 for a square packing arrangement. Thus, we anticipate using a triangular lattice packing fraction would result in a substantially higher aₛᵥ. In comparison to 400 cell per square inch high performance monolith, the geometric surface area is about 22 cm⁻¹. However, as previously noted, monoliths and nearly all others substrates suffer from illumination shadowing effects.

The fiber density, defined as Nf=1/ab, is 25/cm2 for this example. Using this value, the number of fibers needed to create a 5.9 cm-1 geometric surface area in a 5 cm diameter round duct is Nf(□ d2/4), or about 490 fibers. Considering a commercial side emitting fiber strand typically consists of about 170 single fibers, thus 3 strands will produce the desired amount.

A small pressure drop across the reactor is desired to reduce power requirements for gas flow through the reactor. Even with the potential for high packing density, the pressure drop is still small. For example, taking the case for a pressure drop with a 2-meter-long reactor with a surface area to volume ratio of 6 cm-1, F=0.2, a hydraulic diameter of dh=4(1−F)/asv=0.005 m, and a velocity of 9 m/s. The calculated pressure drop for air based on the Darcy-Weibach equation, □ P=2λ (L/dh) (ρ v2/2), where the Darcy-Weibach friction factor □ is taken to be 0.035, is less than 0.1 atm.

Table 1 summarizes the fiber based reactor surface area to volume for various geometries and the fiber number density to achieve the asv value. Note that the actual photocatalyst surface area is much larger since the nanoparticle catalyst film on the fiber optic is highly porous and well dispersed.

TABLE 1
Surface Area-to Volume and Fiber Density

| Diameter fiber (cm) | Separation X (cm) | Separation Y (cm) | Square Area Packing Fraction β | a (cm⁻¹) | Fiber density (fibers/cm²) |
|---|---|---|---|---|---|
| 0.075 | 0.4 | 0.4 | 0.028 | 1.5 | 6 |
| 0.075 | 0.3 | 0.3 | 0.049 | 2.6 | 11 |
| 0.075 | 0.28 | 0.28 | 0.058 | 3.1 | 13 |
| 0.075 | 0.20 | 0.20 | 0.110 | 5.9 | 25 |
| 0.075 | 0.15 | 0.15 | 0.196 | 10.5 | 44 |
| 0.075 | 0.1 | 0.1 | 0.442 | 23.6 | 100 |

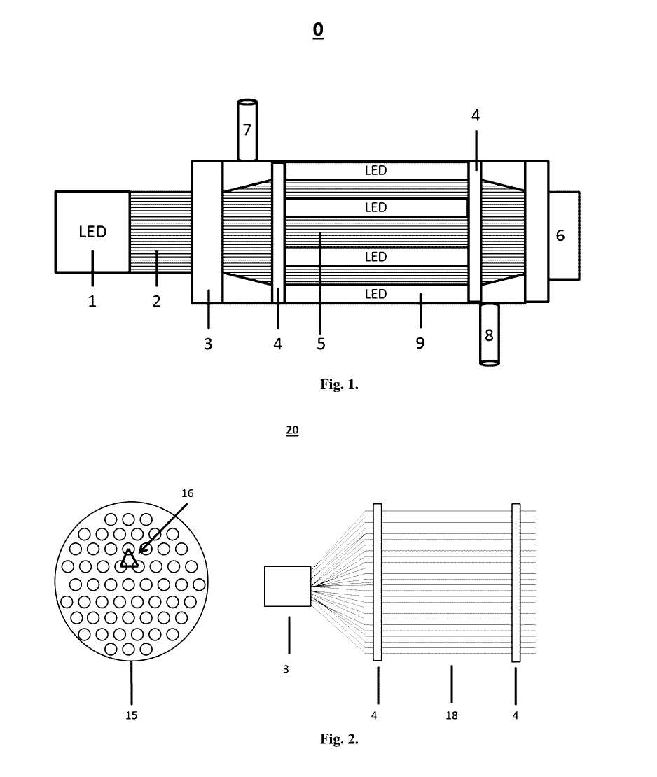

FIG. 1 is a schematic block diagram of the photocatalytic system showing the general operating features of the invention. The system 0 shows a light generating module 1 attached to a fiber optic coupler 2 that gathers light from light generating chamber 1 and positions an array of side emitting fiber optics for light injection into the fiber array. The fiber optic array is fed into a reaction chamber coupler 3 which gathers the fiber optic strands and feeds them into a distributor plate 4. The distributor plate 4 spreads the fiber optics out into an even arrangement consistent with maintaining a high surface to volume ratio and low pressure drop inside reactor chamber 5. The distributor plate also generates an even gas flow field across the fiber optic array to avoid uneven reaction zones. The fiber optics are then gathered together and terminated into a reaction chamber terminator 6. A reactant inlet port 7 delivers a stream of reactants to the reaction chamber 5, and upon the combined action from the light, side emitting fiber optics, and photocatalyst, the oxidized reaction products exit from the reaction chamber at exhaust port 8. A second light generating module 9 attached inside to reaction chamber 5 cross illuminates the fiber optic array for additional illumination of the photocatalyst.

FIG. 2 is a block diagram of the fiber optic distributor plate used in this demonstration to arrange the fiber optics in a geometrically desired orientation inside the reaction chamber. The system 20 shows a distributor plate 15 with a plurality of holes with a diameter large enough to concurrently pass the fiber optic strand and gas flow. A typical outside diameter for a bundle of side emitting fiber optics is 0.7-0.8 mm. To accommodate the fiber optic diameter and gas flow through the hole, a nominal hole diameter of 2 mm was made and placed in a staggered or triangular pattern arrangement 16. The outer diameter of the plate is made to fit into the inside diameter of the reaction chamber. When the fiber strands from the reaction chamber couple 3 are run through the distributor plate 17, the fibers spread out according to the defined geometric hole pattern. The fiber strands 18 extend from the holes for a length of 15-20 cm until they are threaded into a second distributor plate 19. This process is repeated until the desired reactor length is achieved. In this manner, the fiber array is held to a defined geometric arrangement. Keeping the fiber strands to an arrangement described here is beneficial in two regards. First, it keeps the fibers from bunching together to one side of the chamber, which results in the deleterious effect of flow bypassing or channeling around the photocatalyst. Second, since the fiber geometry is reasonably well defined it allows the determination of the surface area to volume ratio. Knowing this value is valuable in design and scale-up of larger systems.

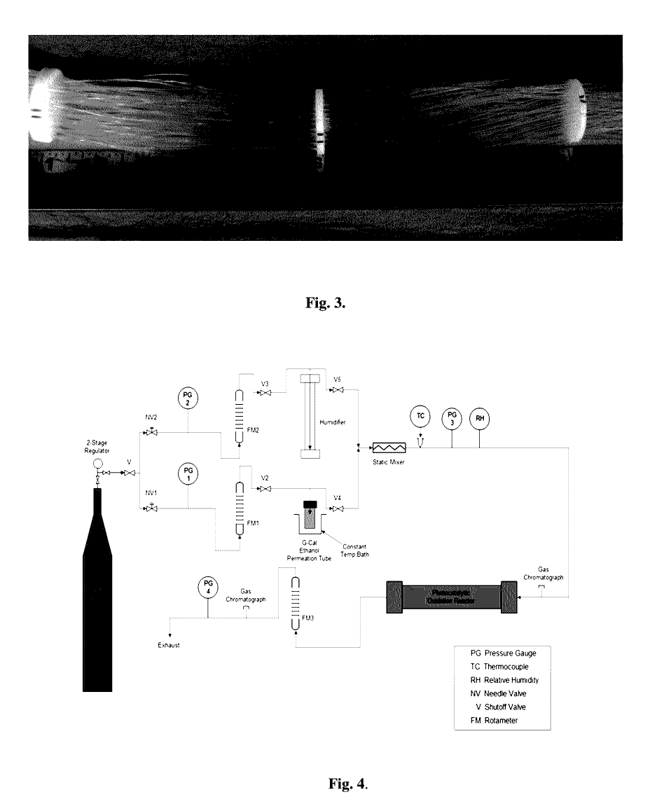

To illustrate the fiber distributor plate process, FIG. 3 is a photograph of a segment of a fiber optic array placed inside of three distributor plates that spreads the fibers out into a distinct geometrical pattern free from entanglement and bunching.

To demonstrate photocatalytic action of volatile organic chemicals using this mode and photochemistry, a test stand was constructed with the essential system elements. The process flow diagram of this apparatus is shown in FIG. 4. The device consists of three main subsystems which are (1) the VOC Gas Delivery, (2) the Photocatalytic Reactor Bed, and (3) the Gas Detection subsystems. The process starts in the VOC Gas Delivery subsystem by splitting dry, carbon free air carrier gas into two streams. One stream passes into a gas sparger filled with water where it is humidified, while the second stream flows to a VOC Generator where the contaminant becomes entrained in the sample gas flow. In these experiments ethanol was chosen as a representative VOC. The ethanol concentration admitted to the reactor chamber was ranged between 20 and 30 ppmv. The flow rate of the humidified carrier gas and VOC streams are regulated and measured with flow control orifices and flow meters. Both streams then recombine, and are passed into a static gas mixer where the streams are thoroughly mixed prior to being sent to the Photocatalytic Reactor Bed. The stream exits the mixer and passes through a relative humidity (RH) and temperature monitor, which records the RH and temperature in real time. Before the gas flows into the reactor, a Gas Chromatography sample port is placed in the stream to withdrawal samples for measuring the initial concentration of the VOC. The humidified VOC gas stream enters the Photocatalytic Reactor through a gas port upstream of the fiber array and distributor plate. The sample stream flows down through the reactor and exits out through a second distributor plate and gas port. Concurrently, a 475 nm LED illuminator propagates a beam of light down through the fiber array and which is then back reflected through the fiber array for a double pass of LED light. A second set of 475 nm LED emitters line the reaction chamber walls for additional light excitation of the photocatalyst surfaces. The reactor flow is then sent to a second Gas Chromatography sample port which measures the reacted VOC outlet concentration. The reactor gas flows are then sent to flow meter and is exhausted.

Various nanoparticle photocatalysts were prepared including Ag/TiO2, Au/TiO2, Ag—Au/TiO2, and Pt/TiO2 using sol gel and impregnation methods, and characterized with UV-Vis absorbance, X-ray diffraction, TEM and EDS methods. The collected UV-VIS spectra of all prepared catalysts indicated a significant absorption feature resonant with the 475 □□nm LED emission band. The X-ray diffraction spectra confirmed crystalline morphology, and the TEM and EDS data indicated good dispersion with particle sizes in the 8-20 nm range.

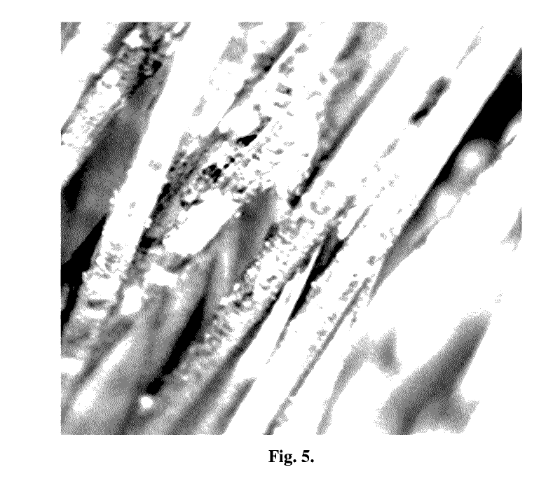

Screening tests were performed on the noble metal photocatalysts and indicated that a 2 wt. % Pt/TiO2 formulation proved the most active towards ethanol. The 2 wt. % Pt/TiO2 catalyst was prepared using the method described by Shiraishi, Y., et al., 2012. This was performed by taking 6 g of TiO2 (anatase) and adding to 117 mL of deionized water with vigorous stirring. Three mL of 8 wt. % H2PtCl6 was added drop-wise to the TiO2/H2O to the solution. The mixture was vigorously stirred while evaporated to dryness at 80° C. and then calcined in air at 400° C. The powder was then reduced with H at the same temperature. The heating rate was 2 degrees/min and held at 400° C. for 2 hours. A photograph of a portion of the photocatalyst coated fiber optic array is presented in FIG. 5.

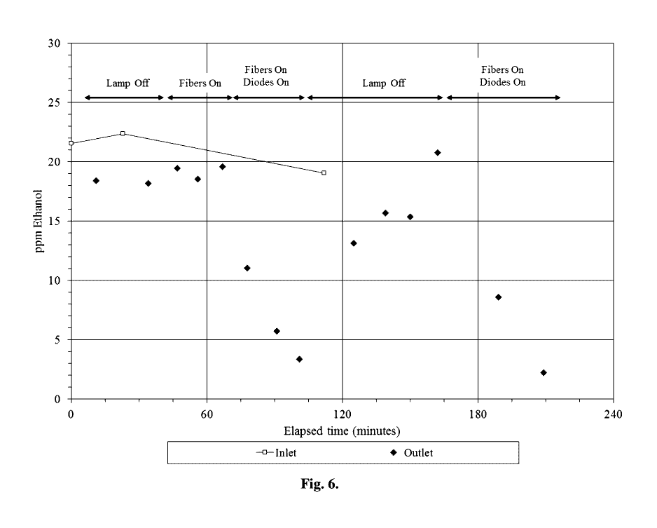

Several tests were performed to demonstrate device performance using the apparatus described above in a once through, continuous mode operation of the reactor. In one test, the ethanol removal in a humidified air stream was tested with the Pt/TiO2 catalyst. The total flow rate that entered the reactor was 1.1 SLPM. The temperature and relative humidity over the test period averaged about 35° C. and 54%, respectively. After initial adsorption of ethanol onto the catalyst and other reactor surface, a steady ethanol concentration at the inlet and outlet stream ports was obtained. The concentration of the ethanol as measured by GC was determined to be 20 ppmv. At this point the LED fiber illuminator and side mounted LEDs were powered on as shown in FIG. 6. Once the light was activated the ethanol began to drop precipitously to 3 ppm in about 45 minutes. A second oxidation cycle was examined as the light sources were turn off. Here the ethanol concentration climbed back to near 21 ppm. Once it stabilized the lamps were activated again and the ethanol was oxidized back to about 2 ppmv. The ethanol conversion percentage, defined as:

% ETOH Conversion=100([ETOH]ᵢₙ−[ETOH]ₒᵤₜ)/[ETOH]ᵢₙ (7)

was used to evaluate the removal efficiency.

The first cycle gave about 85% conversion while the second showed 90%, for an average of 88% ethanol removal over the two oxidation cycles. Additional tests were performed over a range of flow conditions and these are summarized in Table 2. Average values are reported for two cycle times, that is when the lamps are cycle twice on and twice off. The tests indicate a high ethanol removal efficiency in a relatively short reaction time.

TABLE 2
Ethanol Removal Summary

| | Flow Rate | Temperature | Relative Humidity | Average Initial Ethanol | Average Final Ethanol | | Removal Time |
|---|---|---|---|---|---|---|---|
| Test | (SLPM) | (° C.) | (%) | Concentration (ppmv) | Concentration (ppmv) | % Removal | (min.) |
| 1 | 1.1 | 35 | 54 | 25 | 1.7 | 93 | 75 |
| 2 | 1.1 | 35 | 50 | 21 | 2.5 | 88 | 45 |
| 3 | 0.5 | 45 | 50 | 30 | 0.6 | 98 | 75 |
| 4 | 0.4 | 40 | 50 | 30 | 2.1 | 93 | 75 |

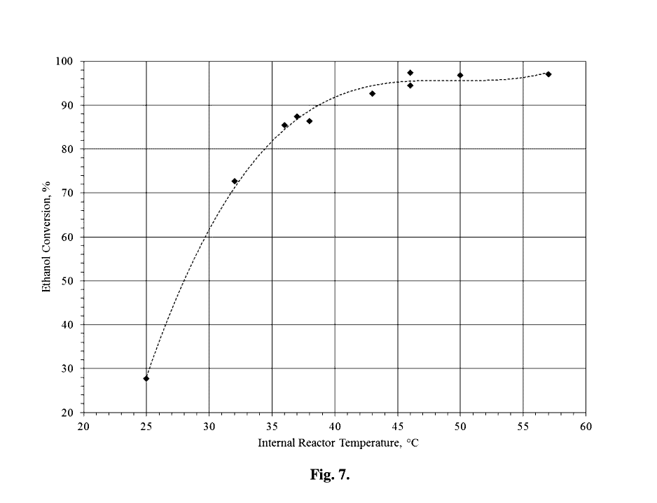

Additional tests indicated that the reaction was temperature dependent. A plot of the ethanol conversion efficiency with internal reactor temperature is presented in FIG. 7, and shows that an optimum temperature is about 45° C. Above this level the reaction levels off and additional heating has a small effect on the ethanol conversion.

### REFERENCES CITED

The entire disclosures of all documents cited throughout this application are incorporated herein by reference.
Asahi, R., Morikawa, T., Ohwaki, T., Aoki, K., Tage, Y., 2001. “Visible-Light Photocatalysts in N Shiraishi, Y., et al., 2012. “Platinum Nano particles Supported on Anatase Titanium Dioxide as Highly Active Catalysts for Aerobic Oxidation under Visible Light Irradiation.,” ACS Catalysis, 2, 1984-1992.
TECHCOMMENTARY, 1996. “Advanced Oxidation Processes for Treatment of Industrial Wastewater”. An EPRI Community Environmental Center Publ. No. 1, 1996.
Turchi, C. S., Rabago, R., and Jassal, A. Semetech, 1995. “Destruction of Volatile Organic Compound (VOC) Emissions by Photocatalytic Oxidation (PCO): Benchscale Test Results and Cost Analysis,” Semetech Technology Transfer 95082935A-ENG.
Zou, X. et al., 2012, “Light-Driven Preparation, Microstructure, and Visible-Light Photocatalytic Property of Porous Carbon Doped TiO2,” International Journal of Photoenergy, Volume 2012, Article ID 720183.
Nitrogen-Doped Titanium Oxides”, Science 293, 269.
Carey, J. H. 1992. “An introduction to AOP for destruction of organics in wastewater.” Water Pollut. Water Pollut. Res. J. Can., 1992, 27, 1-21.
Garcia-Serrano, J., Gmez-Hernandez E., Ocampo-Fernandez M., Pal U., 2009. “Effect of Ag doping on the crystallization and phase transition of TiO₂ nanoparticles,” Current Applied Physics 9, 1097-1105.
Hofstadler, K., Bauer, Novalic, R. S., and Heisler, G., 1994., “New Reactor Design for Photocatalytic Wastewater Treatment with TiO2 Immobilized on Fused-Silica Glass Fibers: Photomineralization of 4-Chlorophenol,” Environmental Science and Technology 28, 670-674.
Hou X. G., Huang M. D., Wu X. L., Liu A. D., 2009. “Preparation and studies of photocatalytic silver-loaded TiO₂ films by hybrid sol-gel method,” Chemical Engineering Journal 146, 42-48.
Marinangeli, R. E. and Ollis, D. F., 1977. “Photoassisted Heterogeneous Catalysis with Optical Fibers 0.1. Isolated Single Fiber,” AIChE J. 23, 415-426.
Okumura, M., Tanaka, K., Ueda, A., Haruta, M., 1997. “The reactivities of dimethylgold(III)β-diketone on the surface of TiO₂: A novel preparation method for Au catalysts,” Solid State Ionics 95, 143.
Peill, N. J. and Hoffmann, M. R., 1995. “Mathematical Model of a Photocatalytic Fiber-Optic Cable Reactor for Heterogenous Photocatalysis,” Environ. Sci. Technol. 29, 2974.
Res. J. Can., 1992, 27, 1-21.

What is claimed is:

1. A device for photocatalytic oxidation of organic compounds comprising:
a) A light source out-put-focused co-linearly into an array of side emitting fiber optics which illuminates the outer surfaces of the fiber optics,
b) A photocatalyst that is deposited onto the surfaces of the side emitting fiber optics that absorbs the radiant light emitted from the side emitted fiber optics to generate an oxidant,
c) A second set of light sources that externally illuminates the photocatalyst coated surfaces of the fiber optics to generate an oxidant,
d) A distributor plate that holds the photocatalyst coated fiber optics into place,
e) A reaction chamber that houses a set of distributor plates, a photocatalyst coated side emitting fiber array, a set of external light sources, a gas inlet source, and a gas outlet source,
f) A reaction chamber inlet for reactant gas that contains a substrate for oxidation and humidity injected into the reaction chamber, and;
g) An exhaust port which acts to remove said oxidation products from the reaction chamber.

2. The device of claim 1 where the light source is a light emitting diode.

3. The device of claim 1 where the co-linear light source output couples internally into the core of the side emitting fiber optic array.

4. The device of claim 1 where a reaction chamber intersects said reactant gas, humidity, distributor plates, photocatalyst coated side emitting fiber optics, and external light sources, and whereby the oxidation of these species proceeds within said reaction chamber,

5. The device of claim 1 where the output from the light sources mounted on the reaction chamber wall couples externally onto the surface of the side emitting fiber optic array.

6. The device of claim 1 where the reaction chamber uses a distributor plate to spread the side emitting optical fibers into a well-defined geometry.

7. The device of claim 1 where the distributor plate disperses the gas reactant flow evenly over the side emitting fiber optic.

8. The device of claim 1 where the side emitting fiber array is geometrically arranged to generate a high reactor surface area to volume ratio.

9. The device of claim 1 where the side emitting fiber optic array is a substrate for which the photocatalyst is deposited onto.

10. The device of claim 1 where a photocatalyst is activated by ultraviolet and visible light wavelengths.

11. The device of claim 1 where a photocatalyst is deposited on the surface of the side emitting fiber array for close-coupling and uniform illumination by the light source.

12. The device of claim 1 where the reaction chamber can be operated in co-flow, counter-flow, and cross-flow configurations.

13. A process for the oxidation of organic compounds using a light source comprising:
a) injection of a reactant gas containing organic compounds, oxygen, and water vapor into a reaction chamber inlet,
b) adsorption of the organic compounds, oxygen, and water onto a photocatalyst surface,
c) focusing and injecting visible light in the spectral region between 400 and 500 nm into the core of the photocatalyst coated side emitting fiber optic, to create oxidant species,
d) chemical reaction and oxidation of the organic compound by the oxidant species formed on the surface of the photocatalyst, and;
e) Exhaust of the oxidized product gas downstream of the photocatalyst coated side emitting fiber optic array and out of the reaction chamber.

14. The process of organic compound oxidation of claim 12 where the oxidant species is a hydroxyl radical.

15. The process of organic compound oxidation of claim 12 where the reactant gas flows from the inlet through a distributor plate to uniformly distribute the gas over the surfaces of a photocatalyst coated side emitting fiber optic array.

16. The process of organic compound oxidation of claim 12 where the photocatalytic reactor is operated at a temperature of around 40-50° C. to achieve maximum organic compound oxidation.

17. The process of organic compound oxidation of claim 12 where the semiconductor photocatalyst is TiO₂.

18. The process of organic compound oxidation of claim 12 where the TiO₂ has a dopant selected from the group consisting of silver, gold, platinum, and silver-gold, or carbon and nitrogen based compounds.

19. The process of organic compound oxidation of claim 12 where an ultraviolet light source in the 300-400 nm wavelength range is used.

20. The process of organic compound oxidation of claim 12 where the side emitting fiber optic core is polymeric organic material, borosilicate, or fused silica.

21. The process of organic compound oxidation of claim 12 where the gas injection flow into the reaction chamber is co-flow, that is the gas flow is in the same direction as the light injection into the side emitting fiber optics.

22. The process of organic compound oxidation of claim 12 where the gas injection flow into the reaction chamber is counter-flow, that is the gas flow is opposite to the direction that the light is injected into the side emitting fiber optics.

23. The process of organic compound oxidation of claim 12 where the gas injection flow into the reaction chamber is cross-flow, that is the gas flow is perpendicular to the direction that the light is injected into the side emitting fiber optics.
